(19) United States
(12) Patent Application Publication
(10) Pub. No.: US 2018/0242789 A1
(43) Pub. Date: Aug. 30, 2018

(54) FRYPAN WITH SPLATTERING FENDER

(71) Applicant: Shenzhen Seefaa Scitech Co., Ltd., Shenzhen (CN)

(72) Inventor: Zhigang Ma, Northville, MI (US)

(21) Appl. No.: 15/869,116

(22) Filed: Jan. 12, 2018

(30) Foreign Application Priority Data
Feb. 24, 2017 (CN) 201720178161.9

(51) Int. Cl. A47J 37/10

(52) U.S. Cl. CPC A47J 37/108

(57) ABSTRACT

A frypan has a splattering fender detachably sitting on the pan body to blocking splattering of cooking oil or food during cooking.

### CROSS-REFERENCE TO RELATED APPLICATIONS

This application claims priority to Chinese patent application No. 201720178161.9, filed on Feb. 24, 2017, the content of which is hereby incorporated by reference.

### BACKGROUND OF THE INVENTION

### 1. Field of the Invention

This disclosure generally relates to cookware and, more specifically, to a frypan or pan or wok, etc., having a splattering fender.

### 2. Description of Related Art

Conventional frypans (including pans, woks, etc.) generally have a bottom portion and a peripheral wall extending up from the bottom. Generally, the peripheral wall is short, which, during cooking, leads to splattering of oil or other stuffs being cooked outside the frypans thus messing up the cooking tops. Further, short peripheral walls also cause the cooking smoke to spread quickly and let the cook to inhale more cooking smoke.

Therefore, it would be desirable to provide a new type of frypan which can at least mitigate the issues with conventional frypans.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is a schematic and perspective diagram, shows an exemplary embodiment of a frypan having a splattering fender;

FIG. 2 is a schematic diagram illustrating a first experiment for splattering pattern of food being cooked in a first conventional frypan;

FIG. 3 is a schematic diagram illustrating a second experiment for splattering pattern of food being cooked in a second conventional frypan;

FIG. 4 is a schematic sectional view of a frypan having a splattering fender, according to an embodiment;

FIG. 5 is another schematic sectional view of a frypan having a splattering fender, according to an embodiment;

FIG. 6 is a schematic sectional view of a splattering fender, according to an embodiment;

FIG. 7 is an enlarged view of circled portion VII in FIG. 4, in accordance with an embodiment;

FIG. 8 is another enlarged view of circled portion VIII in FIG. 5, in accordance with an embodiment;

FIG. 9 is another enlarged view of alternative implementation of an engaging portion VIII of the fryan of FIG. 5, in accordance with an embodiment;

FIG. 10 is an enlarged view of an splattering fender having an annular groove, in accordance with an embodiment;

FIG. 11 is an enlarged view of another splattering fender having an annular groove, in accordance with an embodiment;

FIG. 12 is a schematic diagram illustrating anti-splattering effect with a splattering fender;

FIG. 13 is a schematic diagram of a peripheral wall having an opening therein for a splattering fender, in accordance with an embodiment;

FIG. 14 is a partial schematic diagram of a peripheral wall having an opening therein for a splattering fender, in accordance with an embodiment; and

FIG. 15 is another partial schematic diagram of a peripheral wall having an opening therein for a splattering fender, in accordance with an embodiment.

### DETAILED DESCRIPTION OF THE INVENTION

The invention will now be described in detail through several embodiments with reference to the accompanying drawings.

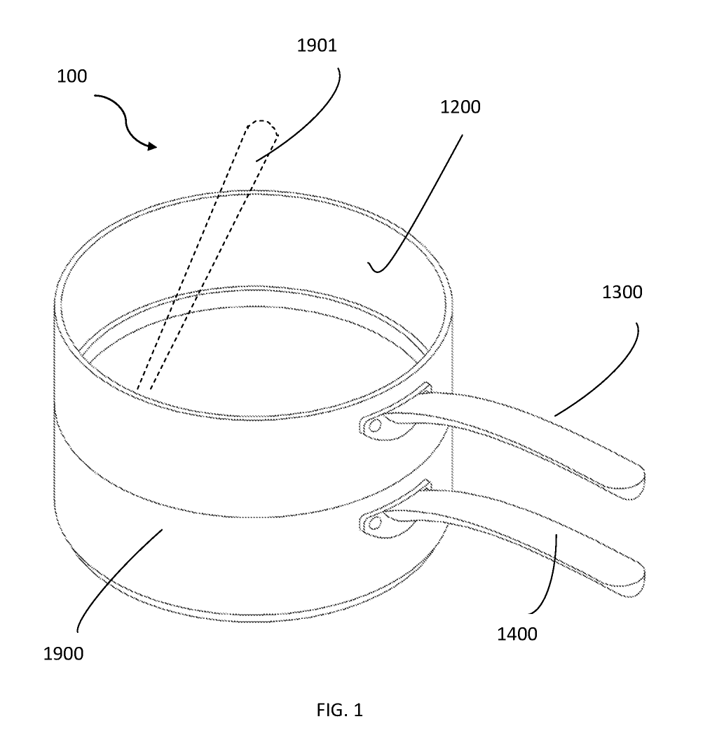

Referring to FIG. 1, a frypan 100 having a splattering fender according to an embodiment is disclosed. Here, the term “fruypan” refers to any pan or wok which can be used to cook food by stirring, flopping, frying, usually involving high temperature and on a stove top or cooking top. The frypan 100 in FIG. 1 includes a pan body 1900 and a splattering fender 1200. The splattering fender is hollow cylinder shaped or substantially so shaped. Here the term “substantially” means approximation, to extent that a person of ordinary skill in the art understands. The pan body 1900 and the splattering fender 1200 can respectively have handles 1400 and 1300 installed for easy handling. A spatula 1901 can reach the pan body 1900 via top of the splattering fender 1200.

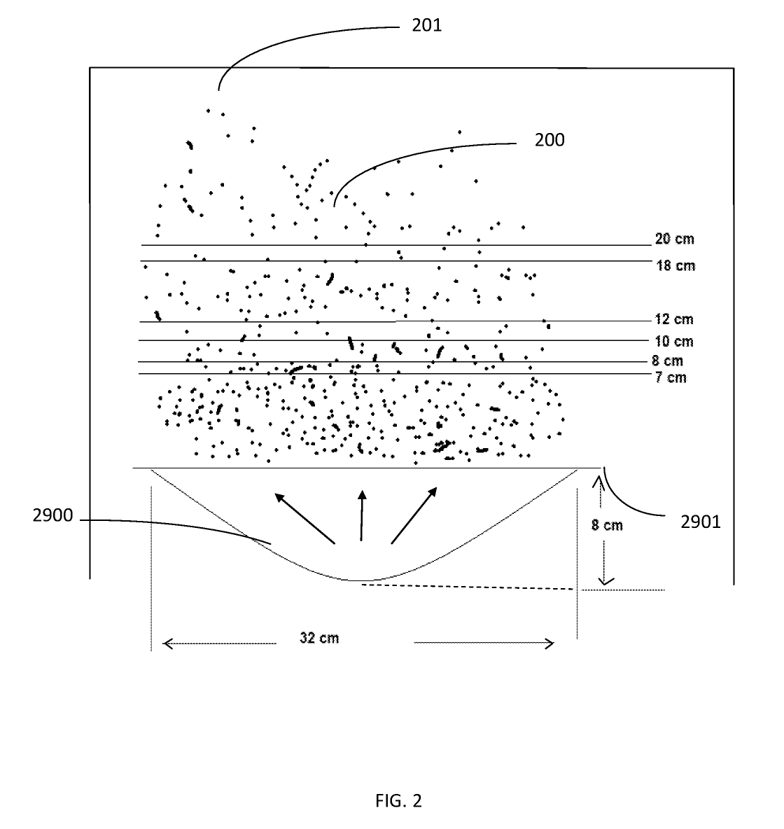

FIG. 2 is a schematic diagram illustrating a first experiment for splattering pattern of food being cooked in a first conventional frypan 2900 without a splattering fender. The frypan 2900 used in the experiment has a overall height of 8 cm, and a inner diameter of 32 cm at its top rim 2901, the body of the frypan 2900 is a wok. The food cooked in the experiment is pepper and meat with cooking oil, with the cooking oil been heated first. The distribution of splattering spots 200 is rendered according to the actual splattering pattern on a cardboard 201 positioned adjacent to the frypan 2900. According to the experiment, from the top rim height 2901 to 7 cm above the top rim 2901, the splattering spots (mainly cooking oil or materials mixed with cooking oil) account for 50% of the total splattering spots in numbers (proximate estimation). Further going up, the splattering spots 200 gradually decreased in numbers. Majority of the splattering spots 200, i.e., about 85% -90%, are below the 20 cm mark. Accordingly, if a splattering fender sitting on the top rim 2901 of the frypan 2900 has height of 20 cm (effectively above the top rim 2901), 85%-95% of the splattering spots 200 will be blocked by the splattering fender, thus keeping the stove top cleaner. On the other hand, the higher the height of the splattering fender, the less maneuverable for operating a spatula to stir the food in the frypan. Considering the size (diameter), height of the a frypan, and the need for maneuverability, different ranges of height of a splattering fender can be used, such as, 5-20 cm, 7-18 cm, 7-15 cm, or 7-12 cm, etc.

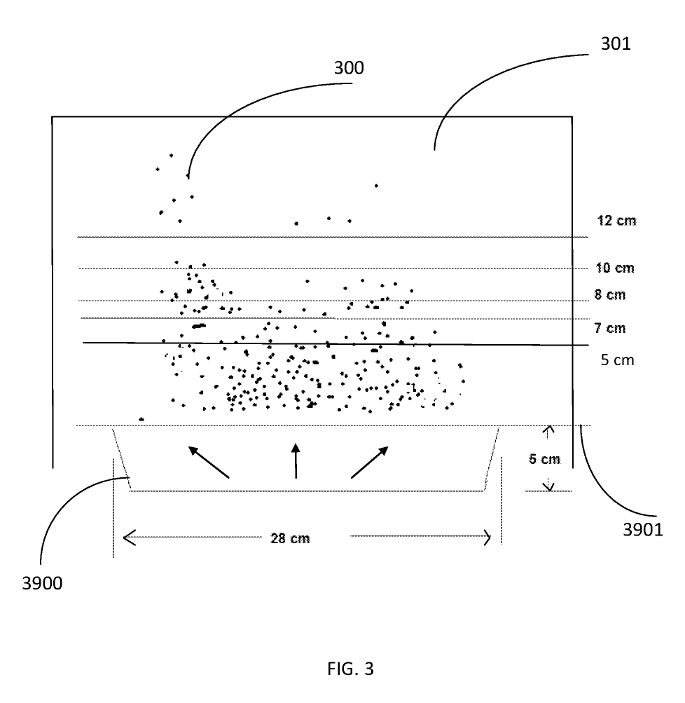

Further referring to FIG. 3, a schematic diagram illustrating a second experiment for splattering pattern of food being cooked in a second conventional frypan 3900 with a flat bottom and without a splattering fender. The frypan 3900 used in the experiment has a overall height of 5 cm, and a inner diameter of 28 cm at its top rim 3901, the frypan 3900 has a flat bottom. The food cooked in the experiment is pepper and meat with cooking oil, with the cooking oil been heated first. The distribution of splattering spots 300 is rendered according to the actual splattering pattern on a cardboard 301 positioned adjacent to the frypan 3900. According to the experiment, from the top rim height 3901 to 5 cm above the top rim 3901, the splattering spots (mainly cooking oil or materials mixed with cooking oil) account for 60% of the total splattering spots in numbers (proximate estimation). Further going up, the splattering spots 300 gradually decreased in numbers. Majority of the splattering spots 300, i.e., about 90%-95%, are below the 12 cm mark. Accordingly, if a splattering fender sitting on the top rim 3901 of the frypan 3900 has a height of 12 cm (effectively above the top rim 2901), 90%-95% of the splattering spots 300 will be blocked by the splattering fender, thus keeping the stove top cleaner. On the other hand, the higher the height of the splattering fender, the less maneuverable for operating a spatula to stir the food in the frypan. Considering the size (diameter), height of the a frypan, and the need for maneuverability, different ranges of height of a splattering fender can be used, such as, 5-12 cm, 5-15 cm, 7-10 cm, or 7-12 cm, etc.

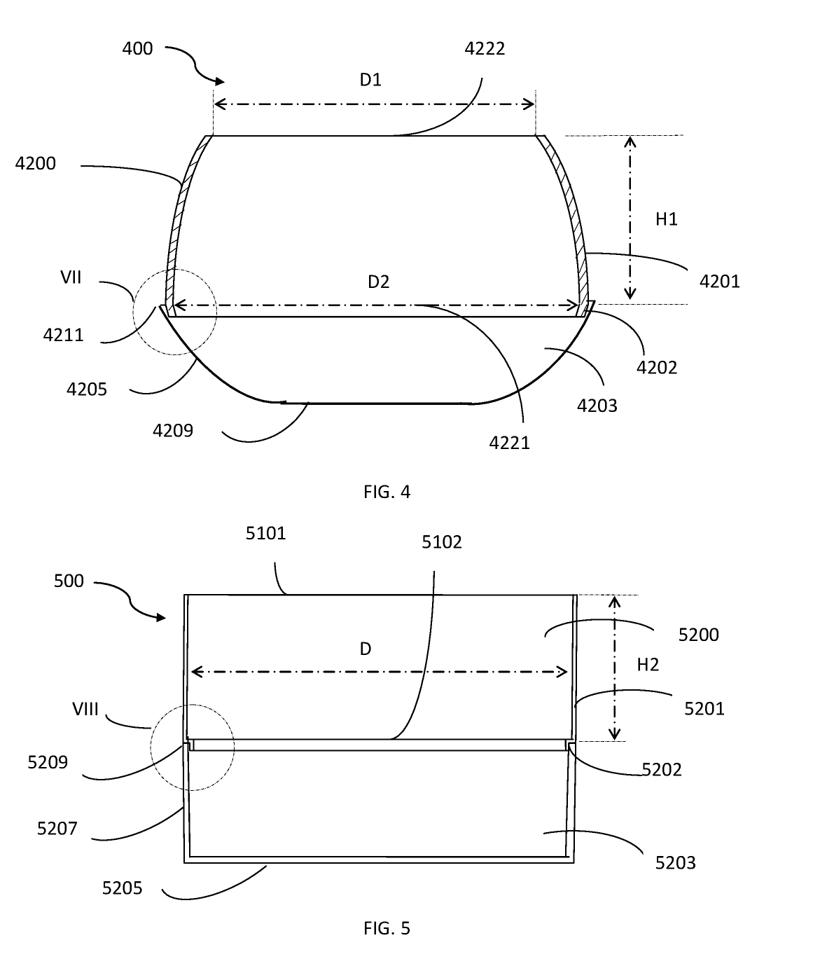

FIGS. 4-11 illustrate different embodiments of a frypan with a splattering fender. Referring to FIG. 4, a frypan 400 includes a splattering fender 4200 and a pan body 4203. The splattering fender 4200 includes a main body 4201 and an engaging portion 4202; the main body 4201 is substantially hollow cylinder shaped, yet also slightly resembles a dome, with two openings 4221 and 4222, with different sizes respectively at the bottom and the top. The two imaginative planes the two lower and upper openings 4221 and 4222 are respectively on can be parallel to each other in the embodiment as shown in FIG. 4, also can form an angle from each other in other embodiments. The pan body includes a bottom portion 4209 and a peripheral wall 4205. The peripheral wall 4205 extends up from the bottom 4209 up and ends up forming an annular rim 4211 at the top thereof. The shape of the annular rim 4211 is substantially matches the shape of the lower opening 4221 as shown in FIG. 4. In other embodiments, the annular rim 4211 and the lower opening 4221 can be shaped in a closed rim other than circular, such as square, oval or rectangular, and the general shape of the main body 4201 can be also shaped differently. In FIG. 4, the diameters of the openings 4222 and 4221 are respectively D1 and D2, and D1 can be 75%-95% of D2. The height H1 of the splattering fender 4200, measuring from the annular rim 4211 can be, according to experiments, ranged 5-15 cm, 5-12 cm, 7-12 cm, 7-15 c, or 7-18 cm.

The engaging portion 4202 of the splattering fender 4200, in FIG. 4, is a engaging wall extending peripherally downward from the lower opening 4211. FIG. 7 shows an enlarged part VII of the engaging portion 4202. When the splattering fender 4200 is placed on the pan body 4203, the engaging wall 7205 is circumferential, positioned inside the peripheral wall 4205 and portion of the engaging wall is lower than the annular rim 4211, thus preventing the splattering fender 4200 from moving away relative to the pan body 4203. In the specific embodiment shown in FIGS. 4 and 7, the engaging wall 7205 is center-ward tilted, and it can contact the inner surface of the peripheral wall 4205 and thus being supported by the peripheral wall 4205, which is slopped. The engaging wall 7205 can be a continuous wall, or an uncontinuous wall formed by a number of teeth 7209 separated by number of spaces 7207 (shown by broken lines).

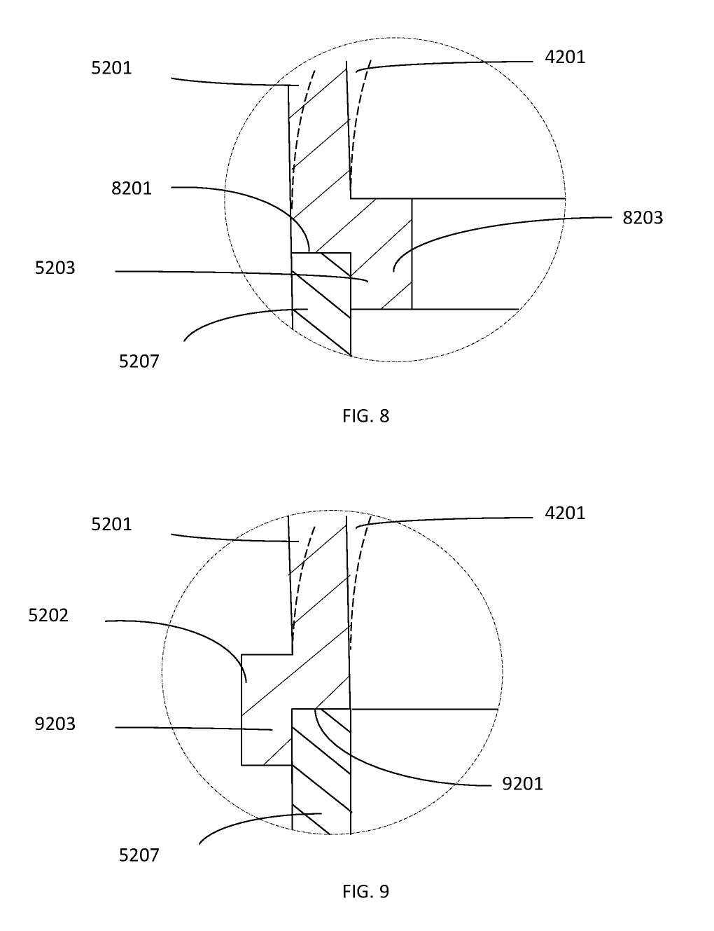

FIG. 5 shows another embodiment of a frypan having a splattering fender. In this embodiment, the frypan 500 includes a pan body 5203 and a splattering fender 5200. The pan body 5203 has a bottom portion 5205 a peripheral wall 5207. The peripheral wall 5207 extends around and up from the bottom portion 5205, forming a hollow cylinder shape. The splattering fender 5200 sits on top of the pan body 5203 to prevent splattering cooking oil or splattering food. The splattering fender 5200 includes a main body 5201 and engaging portion 5202. The main body 5201 is hollow cylinder shaped with an upper opening 5101, and a lower opening 5102, the inner diameter D of the openings 5101 and 5102 are the same, or substantially so, as the inner diameter of the peripheral wall 5207. The engaging portion 5203 in this embodiment is a circumferential wall extending downward from adjacent to the lower opening 5102. Referring to FIG. 8, an enlarged view of portion VIII of FIG. 5, the engaging portion 5202 is formed along the lower end of the main body 5201, adjacent to the lower opening 5102, and forms a circumferential wall 8203, extending downward, and positioned center-ward with a diameter smaller than the outer diameter of the main body, thus forming an annular surface 8201 facing the pan body 5203. The circumferential wall 8203 is located within the peripheral wall 5207 and prevents the splattering fender 5200 from moving relative to the pan body 5203. In FIG. 8, the circumferential wall 8203 is a continuous wall, but as shown in FIG. 7, it can be also an uncontinuous wall in a different embodiment, e.g. as shown in FIG. 7.

FIG. 9 is an enlarged view of portion VIII of FIG. 5 in another embodiment, here, the circumferential wall 9203, unlike the one 8203 in FIG. 8, is positioned outside the peripheral wall 5207, and an annular surface 9201 is located inside the circumferential wall 9203, sitting on the pan body 5203.

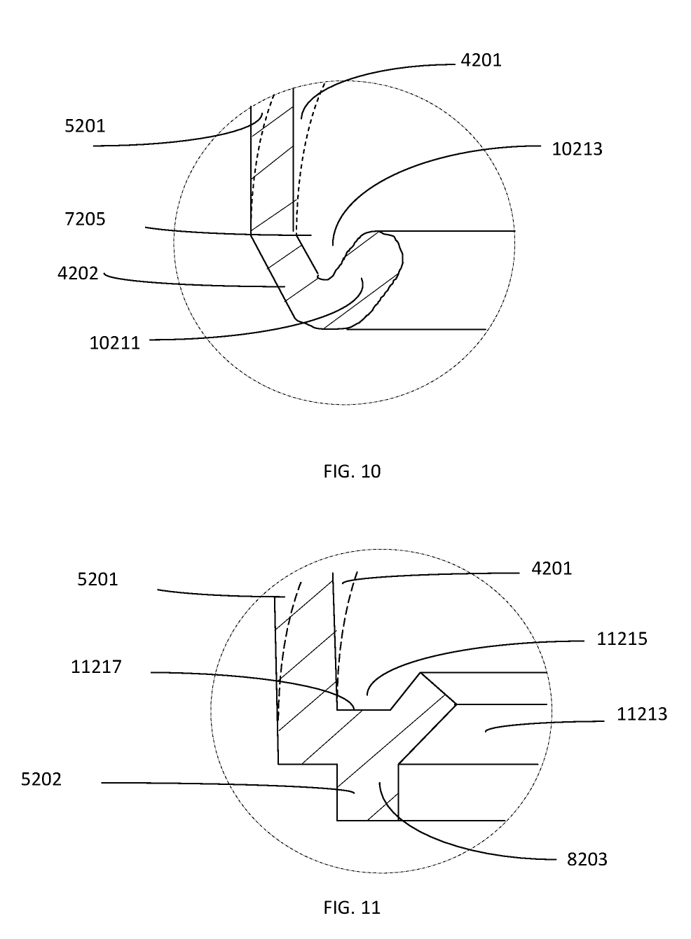

In other embodiments, the splattering fenders 4203 and 5203 can include an annular groove along a inner surface of the splattering fenders, to prevent cumulated cooking oil or food from flowing back to the pan body. Referring to FIG. 10, another enlarged view of portion VII (pan body 4203 omitted), a circumferential edge 10211 extend upward from edge of the circumferential wall 7205, forming an annular groove 10213, together with the circumferential wall 7205, and with an annular opening facing upward. The groove 10213 can keep accumulated cooking oil or food on the inner surface of the splattering fender 4200 from flowing down and mixing with the food being cooked in the pan body 4203. In different embodiments, the groove 10213 can be formed collectively by the circumferential edge 10211, the circumferential wall 7205 and an inner surface of the engaging portion 4201.

Referring to FIG. 11, another enlarged view of portion VIII (pan body 5203 omitted), a circumferential edge 11213 extend upward from top of the circumferential wall 8203, forming an annular groove 11215, together with the inner surface of the main body 5201, and with an opening facing upward. The groove 11215 can keep accumulated cooking oil or food on the inner surface of the splattering fender 5200 from flowing down and mixing with the food being cooked in the pan body 5203. In different embodiments, the groove 10213 can be formed collectively by the circumferential edge , the top of the circumferential wall 8203 as the groove 11215's bottom 11217, and the inner surface of the main body 5201.

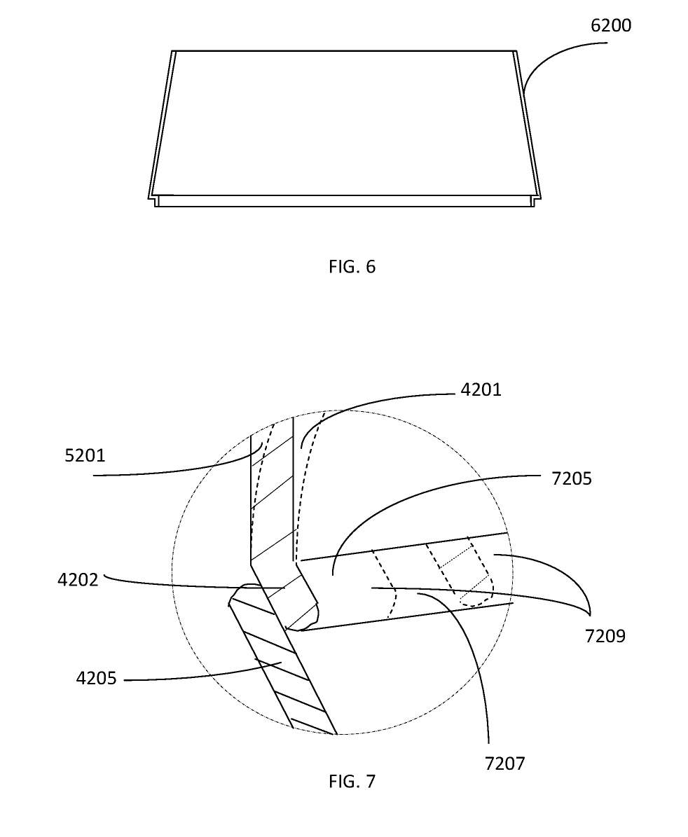

As shown in FIGS. 6-11, the engaging portions 4202 and 5202 can be used for different shapes of main bodies, such as hollow cylinder, dome-shape, or cone shape (as the splattering fender 6200 in FIG. 6). Generally, the splattering fenders 4200 and 5200 are a short tubular structure.

In the embodiments shown in FIGS. 4-11, the splattering fender 4200 or 5200 is detachably or separably sits on the pan body 4203 or 5203, and when the food cooked need to be taken out of the frypan 400 or 500, the splattering fender 4200 or 5200 can be separated from the pan body 4203 or 5203 first, thus only handling the weight of the pan body 4203 or 5203 with easier maneuverability.

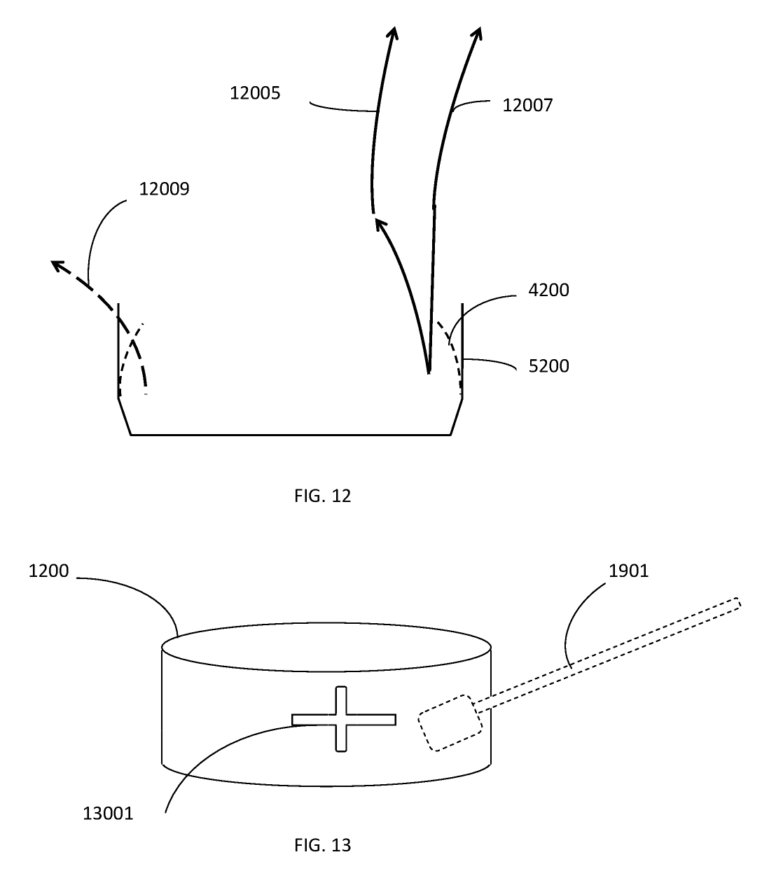

Because of the splattering fender, the frypans described in the embodiments can greatly reduce splattering of cooking oil or food being cooked over the cooking top or stove top. Furthermore, the splattering fender can delay the spreading of cooking smoke to the person who is cooking and force the cooking smoke to rise higher before spreading. This will reduce inhale of cooking smoke by the person, in comparison to using a conventional frypan without the splattering fender. Referring to FIG. 12, the diagram illustrates how the splattering fender can impact the cooking smoke. With the splattering fender 4200 or 5200, the cooking smoke will be forced to flow upward, or more so, along the direction 12005 or 12007, respectively, thus keeping the cooking smoke farther away from the cook, comparing to a conventional frypan that would otherwise likely having a cooking smoke path 12009 to have a bigger impact on the cook.

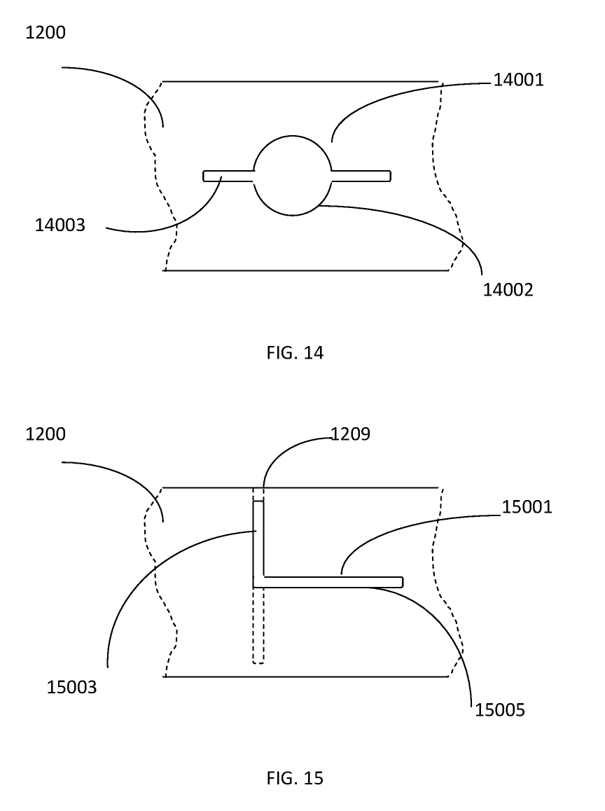

It is understandable that the higher the splattering fender, the better effect in preventing splattering. However, when the splattering fender is too high, it will cause difficulty for the person who is cooking to stir or flip the food in the frypan. On the other hand, with the height of the splattering fender being limited, some splattering cooking oil or food can still come out of the fraypan, and hurt the user of the frypan. In FIG. 13, an opening 13001 is cut in the main body 1200 (or 4200 or 5200). An spatula 1901 or a utensil for stirring of flipping can pass through the opening 13001 to stir the food, meanwhile, the splattering fender 1200 can, to a large extent, shield the cook from being hurt by the splattering cooking oil or food. In the embodiment of FIG. 13, the opening 13001 is cross shaped, the cross is formed by to cross longitudinal slots cut through in the curved wall of the splattering fender 1200. In another embodiment as shown in FIG. 14, a opening 14001 is formed by cutting a horizontal slot 14003 and a circular hole 14002 in the curved wall of the splattering fender 1200; and the diameter of the circular hole 14002 is larger than a width of the horizontal slot 14002 and shorter than a length of the horizontal slot 14003; and the horizontal slot 14002 passes through the circular hole 14002. In yet another embodiment in FG. 15, the opening 15001 is L-shaped, to be more specific, the L-shaped opening 15001 is formed by a vertical slot 15003 and a horizontal slot 15005. In one embodiment, the vertical slot 15003 extends through a upper rim 1209 of the splattering fender for an easy use or passage of the spatula 1901 with the splattering fender 1200. In yet another embodiment, the opening can be T-shaped, like the one shown in FIG. 15 (both solid and broken lines).

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A frypan, comprising:
a pan body, comprising a bottom portion and a peripheral wall extending up from the bottom and forming a first annular rim;
a splattering fender detachably sitting on the annular rim, comprising a main body and engaging portion, wherein the main body is hollow cylinder shaped and an lower portion of the main body comprises a second annular rim sitting on the first annular rim; and the engaging portion extends down from the lower portion to be lower than the first annular rim, thus preventing the splattering fender from moving horizontally relative to the pan body.

2. The frypan of claim 1, wherein the splattering fender further comprises an annular groove formed along an inner surface of the splattering fender with an annular opening facing upward.

3. The frypan of claim 1, wherein a height of the main body of the fender ranges from 5-15 cm.

4. The frypan of claim 1, wherein the engaging portion is a circumferential wall and positioned inside the peripheral wall.

5. The frypan of claim 4, wherein the circumferential wall is uncontinuous.

6. The frypan of claim 1, wherein the engaging portion comprises more than one tooth.

7. The frypan of claim 1, wherein the main body of the splattering fender defines an opening, such that a spatula can pass through the opening to reach inside of the frypan and maneuver via the opening.

8. The frypan of claim 7, wherein the opening is cross shaped to allow the spatula to move horizontally and vertically along the opening.

9. The frypan of claim 7, wherein the opening is form by a horizontal slot and a circular hole; and the diameter of the circular hole is larger than a width of the horizontal slot and shorter than a length of the horizontal slot; and the horizontal slot passes through the circular hole.

10. The frypan of claim 7, wherein the opening is L-shaped.

11. The frypan of claim 10, wherein the L-shaped opening is formed by a vertical slot and a horizontal slot; and the vertical slot extends through a upper rim of the main body.

12. The claim of claim 1, wherein a height of the main body of the fender ranges from 7-18 cm.

13. A frypan, comprising:
a pan body, comprising a bottom portion and a peripheral wall extending up from the bottom and forming a first annular rim at a top of the pan body;
a splattering fender detachably sitting on the circular edge, comprising a main body and engaging portion, wherein the main body is substantially hollow cylinder shaped, and the engaging portion extends down from bottom of the main body downwardly and centerwardly to form a tilted annular wall; the annular wall sits on the annular rim and an end of the annular wall is lower than the annular rim such that horizontal movement of the splattering fender relative to the pan body is limited.

14. The frypan of claim 13, wherein the fender further comprises an annular groove formed along and extending on an inner surface of the fender with an annular opening facing upward.

15. The frypan of claim 13, wherein the main body of the splattering fender defines an opening, such that spatula can pass through the opening to reach inside of the frypan and maneuver via the opening.

16. The frypan of claim 15, wherein the opening is cross shaped to allow the spatula to move horizontally and vertically along the opening.

17. The frypan of claim 15, wherein the opening is form by a horizontal slot and a circular hole; and the diameter of the circular hole is larger than a width of the horizontal slot and shorter than a length of the horizontal slot; and the horizontal slot passes through the circular hole.

18. The frypan of claim 15, wherein the opening is L-shaped.

19. The frypan of claim 18, wherein the L-shaped opening is formed by a vertical slot and a horizontal slot; and the vertical slot extends through a upper rim of the main body.

20. The claim of claim 13, wherein a height of the main body of the fender ranges from 7-18 cm.
